(19) United States
(12) Patent Application Publication
(10) Pub. No.: US 2026/0366569 A1
(43) Pub. Date: Nov. 19, 2026

(54) BEARING

(71) Applicant: Schaeffler Technologies AG & Co. KG, Herzogenaurach (DE)

(72) Inventors: Tao Cheng, Shanghai (CN); Jixuan Liu, Shanghai (CN); Simon Wolf, Kleinlangheim (DE); Robert Godau, Schweinfurt (DE); Tobias Treutlein, Schweinfurt (DE)

(73) Assignee: Schaeffler Technologies AG & Co. KG, Herzogenaurach (DE)

(21) Appl. No.: 19/135,472

(22) PCT Filed: Dec. 5, 2022
(86) PCT No.: PCT/CN2022/136665

§ 371 Date: Jun. 4, 2025

(51) Int. Cl. F16C 33/49; F16C 19/28

(52) U.S. Cl. CPC F16C 33/495; F16C 19/28

(57) ABSTRACT

A bearing includes an outer ring, an inner ring, rolling bodies, and a cage. The cage comprises an annular main body portion and a plurality of extension portions. The plurality of extension portions are provided on the side surface of the main body portion. Adjacent extension portions and part of the main body portion therebetween form pockets for accommodating the rolling bodies. Each extension portion comprises a first extension section and a second extension section. The first extension section is connected to the main body portion. The second extension section is connected to the first extension section. In a direction moving away from the main body portion, radial outer surfaces of the first extension section and the second extension section are both contracted towards the center of the cage.

### CROSS-REFERENCE TO RELATED APPLICATION

This application is a U.S. national stage application under 35 U.S.C. § 371 that claims the benefit of priority under 35 U.S.C. § 365 of International Patent Application No. PCT/CN2022/136665, filed on Dec. 5, 2022, designating the United States of America, the contents of which are relied upon and incorporated herein by reference in their entirety.

### FIELD OF THE DISCLOSURE

The present application relates to the technical field of bearings. More specifically, the present application relates to a bearing that includes a cage.

### BACKGROUND OF THE DISCLOSURE

As shown in FIG. 1, a bearing comprises an outer ring 1′, an inner ring 3′, a cage 4′ and rolling elements 2′. During the assembly of the bearing, due to the constraints of an outer rib of the inner ring and the material characteristics of the cage 1′, the surfaces of the rolling elements 2′ may easily be damaged by the cage 1′ when the rolling elements 2′ are inserted into pockets of the cage 1′.

It is possible to reduce the risk of damaging the rolling elements 2′ by decreasing the height of the outer rib of the inner ring, or an additional mounting groove may be milled on the outer rib of the inner ring to facilitate the mounting of the rolling elements 2′ without damaging the rolling elements 2′. If the height of the outer rib of the inner ring is decreased to reduce the risk of damaging the rolling elements 2′, the rolling elements 2′ are more likely to fall out after the assembly due to the decrease of the height of the outer rib of the inner ring. If the mounting groove is milled on the outer rib of the inner ring to facilitate the mounting of the rolling elements 2′, all of these rolling elements 2′ need to be assembled into the pockets of the cage through the mounting groove, which severely affects the assembly efficiency.

### SUMMARY OF THE DISCLOSURE

An object of the present application is to provide a bearing, which makes it easier to mount rolling elements into pockets of a cage while reducing the risk of damaging the rolling elements during assembly.

A bearing is provided according to the present application, comprising an outer ring, an inner ring, a rolling element and a cage, where the cage comprises:
a main body portion, which is annular; and
multiple extension portions, which are arranged on a side surface of the main body portion, wherein a pocket for accommodating the rolling element is defined by two of the extension portions adjacent to each other and a part of the main body portion between the two of the extension portions; and
each of the extension portions comprises a first extension section and a second extension section, the first extension section is connected to the main body portion, and the second extension section is connected to the first extension section, and outer radial surfaces of the first extension section and the second extension section both narrow towards a center of the cage in a direction away from the main body portion.

According to an embodiment of the present application, on the same radial section, the profile of the outer radial surface of the first extension section is a curve or a straight line, and the profile of the outer radial surface of the second extension section is a curve or a straight line.

According to an embodiment of the present application, the profile of the outer radial surface of the first extension section and the profile of the outer radial surface of the second extension section form a complete curve.

According to an embodiment of the present application, the end point of the profile of an outer radial surface of the main body portion away from the extension portion is represented by P1′, the intersection of the profile of the outer radial surface of the main body portion and the profile of the outer radial surface of the first extension section is represented by P2′, the intersection of the profile of the outer radial surface of the first extension section and the profile of the outer radial surface of the second extension section is represented by P3′, and the end point of the profile of the outer radial surface of the second extension section away from the main body portion is represented by P4′,
wherein the angle between the line connecting P2′ and P3′ and the profile of the outer radial surface of the main body portion is smaller than the angle between the line connecting P3′ and P4′ and the profile of the outer radial surface of the main body portion.

According to an embodiment of the present application, a circle is centered on the center of the cage and passes through P2′, and P1′, P3′ and P4′ are all located inside the circle.

According to an embodiment of the present application, the extension portion further includes a third extension section, which is connected to the second extension section, and an outer radial surface of the third extension section extends from a free end of the second extension section and narrows towards the center of the cage in the direction away from the main body portion.

According to an embodiment of the present application, on the same radial section, the profile of the outer radial surface of the first extension section is a curve or a straight line, the profile of the outer radial surface of the second extension section is a curve or a straight line, and the profile of the outer radial surface of the third extension section is a curve or a straight line.

According to an embodiment of the present application, the profile of the outer radial surface of the first extension section, the profile of the outer radial surface of the second extension section and the profile of the outer radial surface of the third extension section form a complete curve.

According to an embodiment of the present application, the extension portion is provided on each of two side surfaces of the main body portion.

According to an embodiment of the present application, the midpoint of the profile of the outer radial surface of the main body portion is represented by P1, and on any one of the two side surfaces of the main body portion, the intersection of the profile of the outer radial surface of the main body portion and the profile of the outer radial surface of the first extension section is represented by P2, the intersection of the profile of the outer radial surface of the first extension section and the profile of the outer radial surface of the second extension section is represented by P3, and the end point of the profile of the outer radial surface of the second extension section away from the main body portion is represented by P4,
wherein, the angle between the line connecting P2 and P3 and the profile of the outer radial surface of the main body portion is smaller than the angle between the line connecting P3 and P4 and the profile of the outer radial surface of the main body portion.

In the bearing according to the present application, the extension portion comprises the first extension section and the second extension section, and the outer radial surfaces of the first extension section and the second extension section both narrow towards the center of the cage in the direction away from the main body portion. In this way, the material of the outer radial surface of the cage close to the end face of the extension portion is effectively reduced, thereby making it easier to assemble the rolling element into the pocket of the cage and effectively decreasing the risk of damage caused during the assembly of the rolling element. Moreover, the material of other parts of the cage can be maximally retained to avoid compromising the strength of the cage.

### BRIEF DESCRIPTION OF THE DRAWINGS

FIG. 1 is a structural view of a bearing according to the prior art;

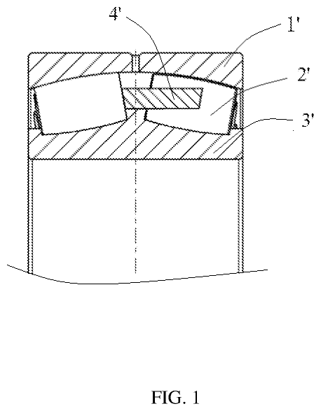

FIG. 2 is a structural view of a bearing according to an embodiment of the present application;

FIG. 3 is an enlarged view of a bearing according to an embodiment of the present application; and

FIG. 4 is an enlarged view of a bearing according to another embodiment of the present application.

### DETAILED DESCRIPTION

An embodiment according to the present application will be described below in combination with the accompanying drawings. The following detailed description and drawings are intended to exemplarily illustrate the principle of the present application, the present application is not limited to the described embodiments, and the scope of protection of the present application is defined by the claims.

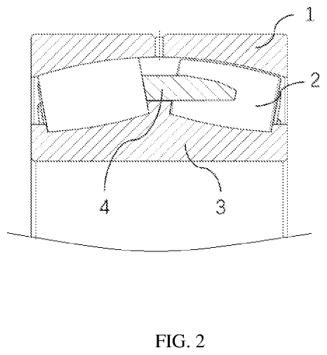

As shown in FIGS. 2-4, a bearing is provided according to an embodiment of the present application. The bearing comprises an outer ring 1, an inner ring 3, a rolling element 2 and a cage 4. The cage 4 comprises a main body portion 41 and multiple extension portions 42 extending from the main body portion 41. The main body portion 41 and the extension portions 42 are made of the same material. In an embodiment, the main body portion 41 and the extension portions 42 are integrated as a single piece, that is, the cage 4 has an integral structure.

The main body portion 41 is the main body of the cage 4 and has an annular shape. The multiple extension portions 42 are arranged on a side surface of the main body portion 41, that is, the multiple extension portions 42 extend outward from the side surface of the main body portion 41. Herein, the multiple extension portions 42 extend outward from an axial side surface of the main body portion 41. A pocket for accommodating the rolling element 2 is defined by two of the extension portions 42 adjacent to each other and the part of the main body portion 41 between the two of the extension portions 42. The rolling element 2 is mounted in the pocket, and the cage 4 is used for retaining the rolling element 2 in the pocket. The cage 4 and the rolling element 2 are arranged between the inner ring 3 and the outer ring 1.

Each of the extension portions 42 comprises a first extension section 421 and a second extension section 422. The first extension section 421 is connected to the main body portion 41, and the second extension section 422 is connected to the first extension section 421. The outer radial surfaces of the first extension section 421 and the second extension section 422 both narrow towards the center of the cage 4 in a direction away from the main body portion 41, that is, the extension portion 42 is segmented. The first extension section 421 and the second extension section 422 are integrally formed. One end of the first extension section 421 is connected to the main body portion 41, and the other end of the first extension section 421 is connected to the second extension section 422. One end of the second extension section 422 is connected to the first extension section 421, and the other end of the second extension section 422 is a free end, in some embodiments.

That is, in some embodiments, the outer radial surface of the cage 4 consists of three profiles, namely the profiles of the main body portion 41, the first extension section 421 and the second extension section 422. The outer radial surface of the main body portion 41 may be cylindrical. The outer radial surfaces of the first extension section 421 and the second extension section 422 both narrow towards the center of the cage 4 in the axial direction away from the main body portion 41, so that the diameter of the outer radial surface of the extension portion 42 decreases in the axial direction. In one example, the outer radial surface of the main body portion 41 is cylindrical. Alternatively, the outer radial surface of the main body portion 41 may be a conical surface with a certain slope, or a curved surface. The outer radial surface of the first extension section 421 narrows towards the radial center or center axis of the cage 4 in the direction away from the main body portion 41 relative to the outer radial surface of the main body portion 41.

The extension portion 42 of the cage 4 may comprise the first extension section 421 and the second extension section 422, and the outer radial surfaces of the first extension section 421 and the second extension section 422 may both narrow towards the center of the cage 4 in the direction away from the main body portion 41. In this way, the material of the outer radial surface of the cage 4 close to the end face of the extension portion 42 is effectively reduced, thereby making it easier to assemble the rolling element 2 into the pocket of the cage 4 and effectively decreasing the risk of damage caused during the assembly of the rolling element 2. Moreover, the material of other parts of the cage 4 can be retained to avoid compromising the strength of the cage 4. Additionally, with the bearing according to the present application, the rolling element 2 can be less likely to fall out of the pocket of the cage 4 while avoiding damaging the rolling element 2 when the rolling element 2 is assembled into the cage 4. Furthermore, milling of an additional mounting groove can be avoided, so assembly is convenient, and the assembling efficiency is improved.

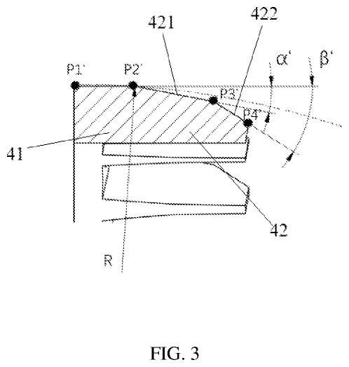

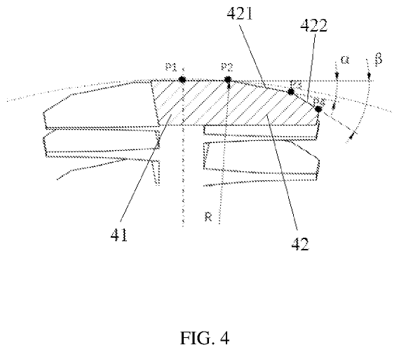

On a same radial section, the profile of the outer radial surface of the first extension section 421 is a curve or a straight line, and the profile of the outer radial surface of the second extension section 422 is a curve or a straight line. As shown in FIGS. 3 and 4, the profile of the outer radial surface of the first extension section 421 is a straight line, and the profile of the outer radial surface of the second extension section 422 is a straight line. That is, the outer radial surface of the first extension section 421 and the outer radial surface of the second extension section 422 are conical surfaces narrowing toward the center of the cage 4. The two sections are inclined to different degrees. The second extension section 422 is inclined toward the center of the cage 4 to a greater degree.

The profile of the outer radial surface of the first extension section 421 and the profile of the outer radial surface of the second extension section 422 form a complete curve. In this way, there is a smoother transition between the outer radial surface of the first extension section 421 and the outer radial surface of the second extension section 422.

According to an embodiment of the present application, the extension portion 42 is provided on only one side surface of the main body portion 41. In this case, the cage 4 is a single-row cage; see FIG. 3 for an example.

In the event that the extension portion 42 is provided on only one side surface of the main body portion 41, the end point of the profile of the outer radial surface of the main body portion 41 away from the extension portion 42 is represented by P1′, the intersection of the profile of the outer radial surface of the main body portion 41 and the profile of the outer radial surface of the first extension section 421 is represented by P2′, the intersection of the profile of the outer radial surface of the first extension section 421 and the profile of the outer radial surface of the second extension section 422 is represented by P3′, and the end point of the profile of the outer radial surface of the second extension section 422 away from the main body portion 41 is represented by P4′.

The angle between the line connecting P2′ and P3′ and the profile of the outer radial surface of the main body portion 41 is smaller than the angle between the line connecting P3′ and P4′ and the profile of the outer radial surface of the main body portion 41. As shown in FIG. 3, the angle between the line connecting P2′ and P3′ and the profile of the outer radial surface of the main body portion 41 is represented by α′, and the angle between the line connecting P3′ and P4′ and the profile of the outer radial surface of the main body portion 41 is represented by β′, where α′<β′. That is, the second extension section 422 narrows towards the center of the cage 4 to a greater degree.

A circle is centered on the center of the cage 4 and passes through P2′, and P1′, P3′ and P4′ are all located inside the circle. As shown in FIG. 3, a circle with a radius R, centered on the center of the cage 4 and passing through P2′, is formed. P1′, P3′ and P4′ are all located inside this circle with the radius R so as to facilitate the assembly of the cage 4 within the outer ring 1.

Further, the extension portion 42 may further include a third extension section, which is connected to the second extension section 422. The outer radial surface of the third extension section extends from the free end of the second extension section 422 and narrows towards the center of the cage 4 in the direction away from the main body portion 41. That is, the extension portion 42 includes the first extension section 421, the second extension section 422 and the third extension section. The first extension section 421 and the second extension section 422 are integrally formed. One end of the first extension section 421 is connected to the main body portion 41, and the other end of the first extension section 421 is connected to the second extension section 422. One end of the second extension section 422 is connected to the first extension section 421, and the other end of the second extension section 422 is connected to the third extension section. One end of the third extension section is connected to the second extension section 422, and the other end of the third extension section is a free end.

The outer radial surface of the cage 4 may consist of four profiles, namely the profiles of the main body portion 41, the first extension section 421, the second extension section 422 and the third extension section. All of the outer radial surfaces of the first extension section 421, the second extension section 422 and the third extension section narrow towards the center of the cage 4 in the direction away from the main body portion 41, so that the diameter of the outer radial surface of the extension portion 42 decreases in the axial direction.

With the bearing according to the present application, the extension portion 42 of the cage 4 comprises the first extension section 421, the second extension section 422 and the third extension section, and all of the outer radial surfaces of the first extension section 421, the second extension section 422 and the third extension section narrow towards the center of the cage 4 in the direction away from the main body portion 41. In this way, the material of the outer radial surface of the cage 4 close to an end face of the extension portion 42 is further effectively reduced, which makes it easier to assemble the rolling element 2 into the pocket of the cage 4 and effectively decreases the risk of damage caused during the assembly of the rolling element 2. Moreover, the material of other parts of the cage 4 can be retained to avoid compromising the strength of the cage 4. Additionally, with the bearing according to the present application, it is possible to make the rolling element 2 less likely to fall out of the pocket of the cage 4 while avoiding damage to the rolling element 2 when the rolling element 2 is assembled into the cage 4. Furthermore, there is no need to mill an additional mounting groove, so assembly is convenient, and the assembling efficiency is improved.

On the same radial section, the profile of the outer radial surface of the first extension section 421 is a curve or a straight line, the profile of the outer radial surface of the second extension section 422 is a curve or a straight line, and the profile of the outer radial surface of the third extension section is a curve or a straight line.

The profile of the outer radial surface of the first extension section 421, the profile of the outer radial surface of the second extension section 422 and the profile of the outer radial surface of the third extension section form a complete curve. In this way, there are smoother transitions among the outer radial surface of the first extension section 421, the outer radial surface of the second extension section 422 and the outer radial surface of the third extension section.

Moreover, the degrees to which the outer radial surface of the first extension section 421, the outer radial surface of the second extension section 422 and the outer radial surface of the third extension section narrow towards the center of the cage 4 increase sequentially. In this way, the material of the outer radial surface of the cage 4 close to the end face of the extension portion 42 is further effectively reduced, thereby making it easier to assemble the rolling element 2 into the pocket of the cage and effectively decreasing the risk of damage caused during the assembly of the rolling element 2. Moreover, the material of other parts of the cage 4 can be retained to avoid compromising the strength of the cage 4.

According to an embodiment of the present application, the extension portion 42 is provided on each of two side surfaces of the main body portion 41. In this case, the cage 4 is a double-row cage; see to FIG. 4 for an example. One side surface of the main body portion 41 is provided with multiple extension portions 42, and the opposite side surface of the main body portion 41 is provided with multiple extension portions 42. The two sets of extension portions 42 share the main body portion 41.

In the event that the extension portion 42 is provided on each of the two side surfaces of the main body portion 41, the midpoint of the profile of the outer radial surface of the main body portion 41 is represented by P1. On either one of the two side surfaces, the intersection of the profile of the outer radial surface of the main body portion 41 and the profile of the outer radial surface of the first extension section 421 is represented by P2, the intersection of the profile of the outer radial surface of the first extension section 421 and the profile of the outer radial surface of the second extension section 422 is represented by P3, and the end point of the profile of the outer radial surface of the second extension section 422 away from the main body portion 41 is represented by P4.

The angle between the line connecting P2 and P3 and the profile of the outer radial surface of the main body portion 41 is smaller than the angle between the line connecting P3 and P4 and the profile of the outer radial surface of the main body portion 41. As shown in FIG. 4, the angle between the line connecting P2 and P3 and the profile of the outer radial surface of the main body portion 41 is represented by α, and the angle between the line connecting P3 and P4 and the profile of the outer radial surface of the main body portion 41 is represented by β, where α<β. That is, the second extension section 422 narrows towards the center of the cage 4 to a greater degree.

A circle is centered on the center of the cage 4 and passes through P2, and P1, P3 and P4 are all located inside the circle. As shown in FIG. 4, a circle with a radius R, centered on the center of the cage 4 and passing through P2, is formed. P1, P3 and P4 are all located inside this circle with the radius R so as to facilitate the assembly of the cage 4 within the outer ring 1.

The bearing according to the embodiment of the present application may be a spherical roller bearing, or may be another type of bearing that requires the cage 4 for mounting of the rolling element 2.

As described above, although the exemplary embodiments of the present application are described with reference to the accompanying drawings in the specification, the application is not limited to the above specific implementations. The scope of protection of the present application is defined by the claims and equivalents thereof.

### LIST OF REFERENCE NUMERALS

Outer ring 1, 1′
Rolling element 2, 2′
Inner ring 3, 3′
Cage 4,4′
Main body portion 41
Extension portion 42
First extension section 421
Second extension section 422

1. A bearing, comprising an outer ring, an inner ring, a rolling element and a cage, wherein the cage comprises:
a main body portion, which is annular; and
a plurality of extension portions, which are arranged on a side surface of the main body portion, wherein a pocket for accommodating the rolling element is defined by two of the extension portions adjacent to each other and a part of the main body portion between the two of the extension portions, and wherein
each of the extension portions comprises a first extension section and a second extension section, the first extension section is connected to the main body portion, the second extension section is connected to the first extension section, and outer radial surfaces of the first extension section and the second extension section both narrow towards a center of the cage in a direction away from the main body portion.

2. The bearing of claim 1, wherein on a radial cross-section, the profile of the outer radial surface of the first extension section is a curve or a straight line, and the profile of the outer radial surface of the second extension section is a curve or a straight line.

3. The bearing of claim 2, wherein the profile of the outer radial surface of the first extension section and the profile of the outer radial surface of the second extension section form a complete curve.

4. The bearing of claim 1, wherein, on a radial cross-section, an end point of the profile of an outer radial surface of the main body portion away from the extension portion is represented by P1′, the intersection of the profile of the outer radial surface of the main body portion and the profile of the outer radial surface of the first extension section is represented by P2′, the intersection of the profile of the outer radial surface of the first extension section and the profile of the outer radial surface of the second extension section is represented by P3′, and the end point of the profile of the outer radial surface of the second extension section away from the main body portion is represented by P4′; and
the angle between the line connecting P2′ and P3′ and the profile of the outer radial surface of the main body portion is smaller than the angle between the line connecting P3′ and P4′ and the profile of the outer radial surface of the main body portion.

5. The bearing of claim 4, wherein a circle is centered on the center of the cage and passes through P2′, and P1′, P3″, and P4′ are all located inside the circle.

6. The bearing of claim 1, wherein the extension portion further comprises a third extension section, which is connected to the second extension section, and an outer radial surface of the third extension section extends from an end of the second extension section and narrows towards the center of the cage in the direction away from the main body portion.

7. The bearing of claim 6, wherein on a radial cross-section, the profile of the outer radial surface of the first extension section is a curve or a straight line, the profile of the outer radial surface of the second extension section is a curve or a straight line, and the profile of the outer radial surface of the third extension section is a curve or a straight line.

8. The bearing of claim 7, wherein the profile of the outer radial surface of the first extension section, the profile of the outer radial surface of the second extension section, and the profile of the outer radial surface of the third extension section form a complete curve.

9. The bearing of claim 1, wherein the extension portion is provided on each of two side surfaces of the main body portion.

10. The bearing of claim 9, wherein a midpoint of the profile of an outer radial surface of the main body portion is represented by P1, on any one of the two side surfaces of the main body portion, the intersection of the profile of the outer radial surface of the main body portion and the profile of the outer radial surface of the first extension section is represented by P2, the intersection of the profile of the outer radial surface of the first extension section and the profile of the outer radial surface of the second extension section is represented by P3, and the end point of the profile of the outer radial surface of the second extension section away from the main body portion is represented by P4, and wherein the angle between the line connecting P2 and P3 and the profile of the outer radial surface of the main body portion is smaller than the angle between the line connecting P3 and P4 and the profile of the outer radial surface of the main body portion.

11. A bearing, comprising:
an outer ring;
an inner ring;
a plurality of rolling elements disposed between the outer ring and the inner ring; and
a cage retaining and spacing the plurality of rolling elements, the cage comprising:
an annular main body having opposite axial side faces; and
a plurality of axially-projecting extension portions provided on at least one of the axial side faces of the main body, wherein adjacent ones of the extension portions cooperate with an intervening portion of the main body to define a pocket that receives at least one of the plurality of rolling elements, wherein each extension portion comprises:
a first extension section fixed to and extending axially from the main body; and
a second extension section fixed to and extending axially from the first extension section toward a free end of the extension portion that is distal from the main body, wherein, on a radial cross-section of the cage, an outer radial surface of the first extension section and an outer radial surface of the second extension section each taper radially inward toward a center axis of the cage as the first and second extension sections extend axially away from the main body, such that a radial dimension of the extension portion decreases in successive steps from the main body toward the free end of the extension portion.

12. The bearing of claim 11, wherein, on the radial cross-section, the outer radial surface of at least one of the first extension section and the second extension section is a straight line.

13. The bearing of claim 11, wherein, on the radial cross-section, the outer radial surfaces of the first and second extension sections together form a complete curve.

14. The bearing of claim 11, wherein, on the radial cross-section, the outer radial surface of the second extension section tapers toward the center axis at an angle that is greater than an angle that the outer radial surface of the first extension section tapers toward the center axis.

15. The bearing of claim 11, wherein, on the radial cross-section, a circle centered on the center axis of the cage and passing through an intersection of an outer radial surface of the main body and the outer radial surface of the first extension section encloses an axial midpoint of the outer radial surface of the main body, an intersection of the outer radial surface of the first extension section and the outer radial surface of the second extension section, and an end point of the outer radial surface of the second extension section that is axially distal from the first extension section.

16. The bearing of claim 11, wherein each extension portion further comprises:
a third extension section joined to the second extension section, an outer radial surface of the third extension section tapering radially inward toward the center axis as the third extension section extends axially away from the main body.

17. The bearing of claim 16, wherein, on the radial cross-section, the outer radial surfaces of the first, second, and third sections together form a complete curve.

18. The bearing of claim 11, wherein extension portions are provided on both axial side faces of the main body, such that the cage is configured to retain two rows of the rolling elements.
